(19) United States
(12) Patent Application Publication
(10) Pub. No.: US 2012/0038911 A1
(43) Pub. Date: Feb. 16, 2012

(54) DEFECT DETECTION APPARATUS

(76) Inventors: Tatsuya YOSHIHIRO, Kanagawa (JP); Hiroshi Sunagawa, Kanagawa (JP); Hisashi Ootsuka, Kanagawa (JP); Takeharu Tani, Kanagawa (JP)

(21) Appl. No.: 13/191,096

(22) Filed: Jul. 26, 2011

(30) Foreign Application Priority Data
Aug. 12, 2010 (JP) 2010-180833

(51) Int. Cl. G01N 21/88

(52) U.S. Cl. 356/237.5

(57) ABSTRACT

There is provided a defect detection apparatus including: a light illumination section; a group of lenses including an object lens and a focusing lens; a light splitter section that splits the light passing through the lens group into two beams; a deflecting section; a phase shifting section that shifts the phase of the at least one of the beams from the two beams; a wave combining section that wave combines the two beams phase shifted by the phase shifting section; and an imaging section that captures an optical image of light wave combined by the wave combining section, wherein the object lens and the focusing lens are disposed such that two beams that have passed through the focusing lens are parallel to each other and the main axes of the two beams that have passed through the focusing lens are parallel to each other.

### CROSS-REFERENCE TO RELATED APPLICATION

This application is based on and claims priority under 35 USC 119 from Japanese Patent Application No. 2010-180833 filed on Aug. 12, 2010, the disclosure of which is incorporated by reference herein.

### BACKGROUND

1. Technical Field

The present invention relates to a defect detection apparatus, and in particular to a defect detection apparatus utilizing an optical interference system.

2. Related Art

According to a semiconductor lithography roadmap (for example SEMATECH Lithography Forum 2008), the next generation circuit line width HP in 2016 is expected to be 16 to 22 nm. There are investigations into the extension of existing size-reduction projection light exposure methods, and new use of nanoimprint lithography (NIL) for the next generation of light exposure apparatuses and methods.

With the former optical method, due to resolution being insufficient with light exposure with currently employed ArF lasers oscillating with a wavelength of 193 nm, research and development is proceeding at a fast pace into double patterning that uses an liquid immersion method and requires an EUV light source of 13.5 nm wavelength. There are issues with such a liquid immersion method regarding the reduction in throughput and increase in cost due to light exposure being performed two times. The EUV light source has a wavelength that is shorter by at least one decimal place than an ArF laser, resulting in an extremely high degree of difficulty in research towards putting such a light source and optical system into practice.

In contrast, nanoimprint technology is being employed as a technique for semiconductor fabrication. Nanoimprint technology is a molding processing technique in which a nanoimprint mold formed with a pattern of recesses and projections of a nanometer scale is pressed against a substrate coated with a thin resin film, thereby imparting a pattern of recesses and projections in the thin resin film.

A nanoimprint technology method enables nanometer scale production more simply and at a lower cost than, for example, photolithography techniques.

Optically there are two significant differences between a conventional light exposure mask and a nanoimprint mold.

(1) Fineness of Defect Size (Influence of a Same Magnification Optical System)

In contrast to a conventional semiconductor light exposure incorporating a 4-fold reducing optical system, a same magnification mold is employed in nanomprinting. Consequently, in contrast to a light exposure mask with a permissible defect size of 10 nm to 100 nm that is four times the semiconductor product defect size, the defect size in nanoimprint molds needs to be suppressed to about 10 nm, equivalent to the permissible defect size of the semiconductor itself. Such a defect size is smaller by at least a decimal place than the wavelength of an illumination beam (DUV light/193 nm of deep ultraviolet ArF laser).

(2) Optical Properties of Measurement Sample

A light exposure mask is manufactured with a pattern of a metal (mainly Cr) on a transparent quartz substrate. Chromium is both non-transparent and also has metallic glossiness, accordingly light illuminated on a sample is reflected/scattered or absorbed, resulting in a large difference in light intensity between transmitted light and reflected light. The presence or absence of defects can accordingly be detected directly as brightness and darkness in the light. However, in a nanoimprint mold, due to forming a pattern by recesses and projections on a quartz substrate itself, defects amount to no more than the fine level differences of recesses and projections in a transparent body. Accordingly, with a nanoimprint mold, since only fine displacements in phase occur even when there are defects present, the intensity of transmitted light is equivalent whether or not defects are present (such an object is sometimes referred to below as a “phase object”).

Both of these points of difference result in making the detection of defects in a nanoimprint mold more difficult.

A method using an interference microscope, as described for example in Japanese Patent Application Laid-Open (JP-A) No. 8-327557, is proposed as a method for detecting recesses and projections of a transparent material (phase object).

An apparatus is described in JP-A No. 8-327557 that performs detection by optically extracting defect portions by optically subtracting non-defective portions of a pattern.

There is also a technique described in non-patent publication “Dainana Hikari no Enpitsu” Volume 25 by Tadao TSURUTA for emphasizing scattered light intensity by interfering a scattered light component and an illumination beam with a phase difference of π−Δ.

FIG. 12 illustrates a defect detection apparatus 100 similar to a defect detection apparatus described in JP-A No. 8-327557. Explanation follows regarding detection of a defect in a nanoimprint mold 12 with the defect detection apparatus 100.

As shown in FIG. 12, the defect detection apparatus 100 is a field separation interference microscope including: a light source 14 that illuminates a parallel light illumination beam onto the nanoimprint mold 12; a focusing lens 17 that converges light that has passed through the nanoimprint mold 12; a half-mirror 18 that light from the focusing lens 17 into two directions; a deflector 20A that deflects light that has passed through the half-mirror 18; a mirror 22 that reflects the light deflected by the deflector 20A towards a specific direction; a phase compensation plate 24 for performing phase compensation; a deflector 20B for deflecting light reflected by the half-mirror 18; a mirror 26 that reflects the light deflected by the deflector 20B towards a specific direction; a phase shifter 28 that shifts the phase of light from the mirror 26; a half-mirror 30 for letting light pass through from the phase shifter 28 and wave combining by reflecting light from the phase compensation plate 24; and an imaging element 34 for capturing an optical image of light wave combined by the half-mirror 30.

Out of the light passing through the nanoimprint mold 12, scattered light L1 scattered by a pattern formed on the nanoimprint mold 12 passes through the focusing lens 17 and is incident on the half-mirror 18. The scattered light L1 light incident on the half-mirror 18 is split into scattered light L11 that passes through the half-mirror 18, and scattered light L12 that is reflected by the half-mirror 18. In FIG. 12, only the scattered light L1 out of the light that has passed through the nanoimprint mold 12 is shown.

The scattered light L11 that has passed through the half-mirror 18 goes on to pass through the deflector 20A, and is then reflected towards the phase compensation plate 24 by the mirror 22.

The phase compensation plate 24 functions to adjust the relative phase difference between the scattered light L11 and the scattered light L12, namely functions to adjust such that the optical path lengths of the scattered light L11 and the scattered light L12 are the same as each other. The scattered light L11 that has passed through the phase compensation plate 24 is then incident on the half-mirror 30.

The scattered light L12 reflected by the half-mirror 18 passes through the deflector 20B and is reflected towards the phase shifter 28 by the mirror 26.

The phase shifter 28 is configured by wedge shaped prisms 28A, 28B. By shifting the prism 28A in the arrow P direction in the drawing, the optical path difference between the scattered light L11 and the scattered light L12 can be adjusted according to the shift amount, namely the phase shift amount can be adjusted.

The light from the phase shifter 28 and the light from the phase compensation plate 24 are wave combined by the half-mirror 30. The wave combined light is imaged on the imaging element 34 by a focusing lens.

Due to the defect detection apparatus 10 configured as described having a field separation function, a single image point and a conjugate object point can both be formed on the imaging element 34. More specifically, parallel shifting can be performed so that the scattered light L11, L12 move apart from each other in a direction parallel to the image plane of the imaging element 34 (an arrow P direction) when the deflectors 20A, 20B are inclined with respect to the optical axes by respective specific angles θ in opposite directions. Accordingly, by tilting the deflectors 20A, 20B by the specific angle θ, out of the two object points P1, P2 separated by the separation distance D in the arrow P direction on the nanoimprint mold 12, an interference image resulting from interference between a field separation image of the scattered light L11 that is light from the object point P1 and a field separation image of the scattered light L12 that is light from the object point P2 can be formed as an image on the imaging element 34.

Consequently, light from the two object points separated on the nanoimprint mold 12 can be caused to interfere and an image can be formed on the imaging element 34 by inclining the deflectors 20A, 20B by a specific angle θ that depends on the separation distance D.

As shown in FIG. 13, out of light that has passed through the nanoimprint mold 12, the illumination beam L2, similarly to the scattered light L1, passes through the focusing lens 17 and is the incident on the half-mirror 18. The illumination beam L2 that is incident on the half-mirror 18 is split into an illumination beam L21 that passes through the half-mirror 18 and an illumination beam L22 that is reflected by the half-mirror 18. Note that in FIG. 13 only the illumination beam L2 is shown from the light that has passed through the nanoimprint mold 12.

With respect to the illumination beam L2, similarly to the scattered light L1, the illumination beams L21, L22 are parallel shifted by the deflectors 20A, 20B and incident to the imaging element 34, however, as shown in FIG. 13, due to the wave face of the illumination beams L21, L22 being the spherical wave faces L21A, L22B, interference fringes are generated in the image captured by the imaging element 34 when the illumination beams L21, L22 are parallel shifted. These interference fringes are changes in the signal intensity SB of the illumination light, and due to light intensity change noise and the like it is difficult to detect the scattered light L1, namely to detect defects.

FIG. 14 illustrates a defect detection apparatus 101 equipped with a different optical interference system to that of the defect detection apparatus 100. As shown in FIG. 14, the defect detection apparatus 101 employs the half-mirror 18 also as a deflector, and employs the mirror 22 also as a phase shifter. Other parts of the configuration are similar to those of the defect detection apparatus 100.

The half-mirror 18 has a similar function to that of the deflectors 20A, 20B described above, and is capable of laterally shifting the two split beams in the arrow P direction in the drawing by pivoting about the deflection direction center point C.

The mirror 22 also has a similar function to that of the phase shifter 28 described above, and is capable of adjusting the phase difference between the two separated beams by movement of the mirror 22 in a direction orthogonal to the arrow P direction in the drawing.

In the defect detection apparatus 101 too, similarly to in the defect detection apparatus 100, an interference image from interference between the scattered light L11 and the scattered light L12 can be formed as an image on the imaging element 34.

As shown in FIG. 14, the illumination beam L2, similarly to the scattered light L1, is split into the two illumination beams L21, L22 and is also shifted laterally in the arrow P direction in the drawing by the half-mirror 18.

However, as shown in FIG. 14, after having passed through the focusing lens 17, the illumination beams L21, L22 are not parallel to each other due to deflection by the half-mirror 18. As a result, when the illumination beams L21, L22 interfere with each other, the signal intensity SB of the illumination light changes similarly to in the defect detection apparatus 100 due to the wave faces L21A, L22A being tilted, and interference fringes are generated in the image captured by the imaging element 34, making it difficult to detect defects.

### SUMMARY

The present invention addresses the above issues and is directed towards provision of a defect detection apparatus capable of detecting defects with high precision when detecting defects of a detection subject using an optical interference system.

To address the above issues, a first aspect of the present invention provides a defect detection apparatus including:

a light illumination section that illuminates an illumination beam onto a detection subject that transmits light and is formed with a predetermined pattern;

a group of lenses including an object lens and a focusing lens for focusing the illumination beam illuminated on and passing through the detection subject;

a light splitter section that splits the light passing through the lens group into two beams;

a deflecting section that deflects at least one of the two beams from the two split beams so as to be laterally shifted along a predetermined direction;

a phase shifting section that shifts the phase of the at least one of the beams from the two beams deflected by the deflecting section;

a wave combining section that wave combines the two beams phase shifted by the phase shifting section; and

an imaging section that captures an optical image of light wave combined by the wave combining section, wherein the object lens and the focusing lens are disposed such that two beams that have passed through the focusing lens are parallel to each other and the main axes of the two beams that have passed through the focusing lens are parallel to each other.

According to the present invention, due to the object lens and the focusing lens being disposed such that the two beams that have passed through the focusing lens and the main axes of the two beams that have passed through the focusing lens are parallel to each other, no interference fringes are generated in the captured image even though the two beams interfere with each other, and so defects can be detected with high precision.

A second aspect of the present invention provides the defect detection apparatus of the first aspect, wherein the object lens and the focusing lens are disposed such that the back focal point position of the object lens and the front focal point position of the focusing lens coincide with each other.

A third aspect of the present invention provides the defect detection apparatus of the second aspect, wherein:

the focusing lens is provided between the wave combining section and the imaging section; and

the light splitter section comprises a half-mirror that causes a portion of the light passed through the object lens to pass through and reflect another portion of the light passed through the object lens;

the light splitter section also functions as the deflecting section; and the object lens, the focusing lens and the half-mirror are disposed such that the deflection direction central point of the half-mirror is at the back focal point position of the object lens and at the front focal point position of the focusing lens.

A fourth aspect of the present invention provides the defect detection apparatus of the second aspect, wherein:

a relay lens is provided on an optical path between the object lens and the focusing lens; and

the deflecting section is also employed as a mirror that reflects the light that has passed through the half-mirror towards the wave combining section, and the object lens, the focusing lens and the half-mirror are disposed such that the deflection direction central point of the mirror is at the back focal point position of the object lens and at the front focal point position of the focusing lens.

A fifth aspect of the present invention provides the defect detection apparatus of the fourth aspect, further comprising a mask section disposed at a Fourier transform plane where an optical image of a Fourier transform pattern corresponding to the pattern is formed, the mask section configured to cut out an optical image of the Fourier transform pattern.

A sixth aspect of the present invention provides the defect detection apparatus of the first aspect, wherein the focusing lens is provided between the object lens and the light splitter section.

A seventh aspect of the present invention provides the defect detection apparatus of the first aspect, wherein:

the light illumination section illuminates an illumination beam of wavelength greater than nanometer size onto a nanoimprint mold that transmits light and is formed with a predetermined pattern of nanometer size; and

the phase shifting section shifts the phase of at least one of the beams from the two beams such that the phase difference between the two beams deflected by the deflecting section is π−Δ(−90°<Δ<90°).

According to the present invention, an effect is exhibited by which defects can be detected at high precision when detecting for defects in a detection subject using an optical interference system.

### BRIEF DESCRIPTION OF THE DRAWINGS

Exemplary embodiments of the present invention will be described in detail based on the following figures, wherein:

FIG. 1 is a configuration diagram of a defect detection apparatus according to a first exemplary embodiment;

FIG. 2 is a bloc diagram of a control system of a defect detection apparatus according to the first exemplary embodiment;

FIGS. 3A and 3B are explanatory diagrams regarding detection of an isolated defect;

FIG. 4 is a diagram illustrating an image captured of an isolated defect;

FIG. 5 is a graph illustrating measurement results of the contrast of a simulated defect and the contrast of background light;

FIG. 6 is a diagram illustrating an image captured of an isolated defect;

FIG. 7 is an explanatory diagram regarding detecting a defect in a cell by interfering an image of an adjacent cell;

FIG. 8 is an explanatory diagram regarding detecting defects in a die by interfering an image of an adjacent die;

FIG. 9 is a configuration diagram of a defect detection apparatus according to a second exemplary embodiment;

FIG. 10 is a configuration diagram of a defect detection apparatus according to the second exemplary embodiment;

FIG. 11 is a configuration diagram of a defect detection apparatus according to a third exemplary embodiment;

FIG. 12 is a configuration diagram of a defect detection apparatus according to a related example;

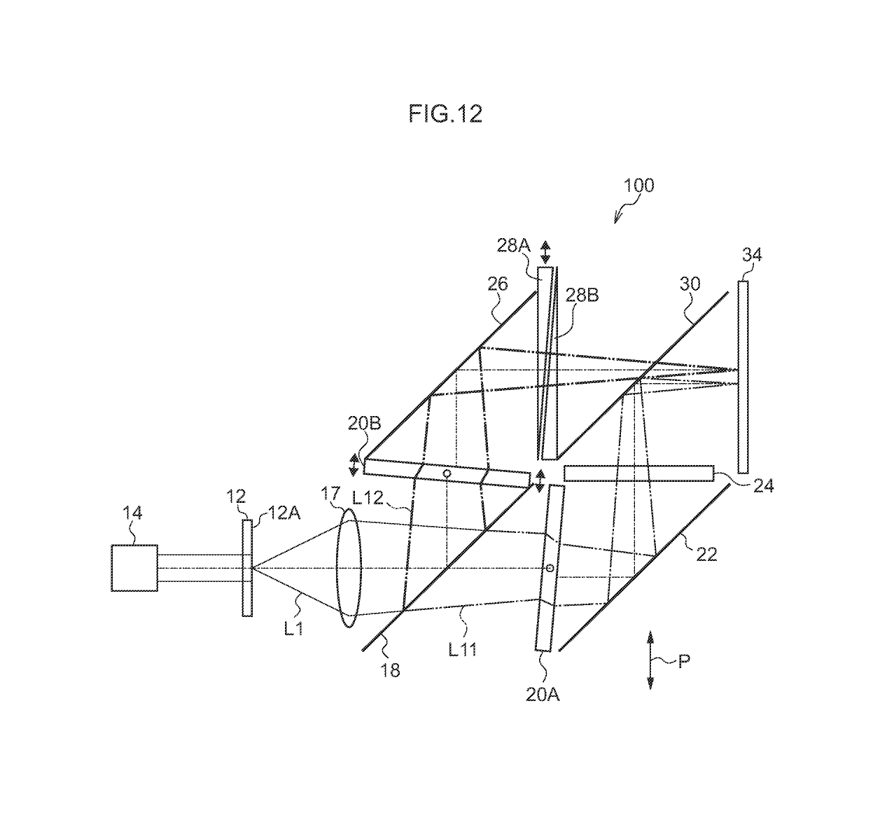

FIG. 13 is a configuration diagram of a defect detection apparatus according to a related example; and

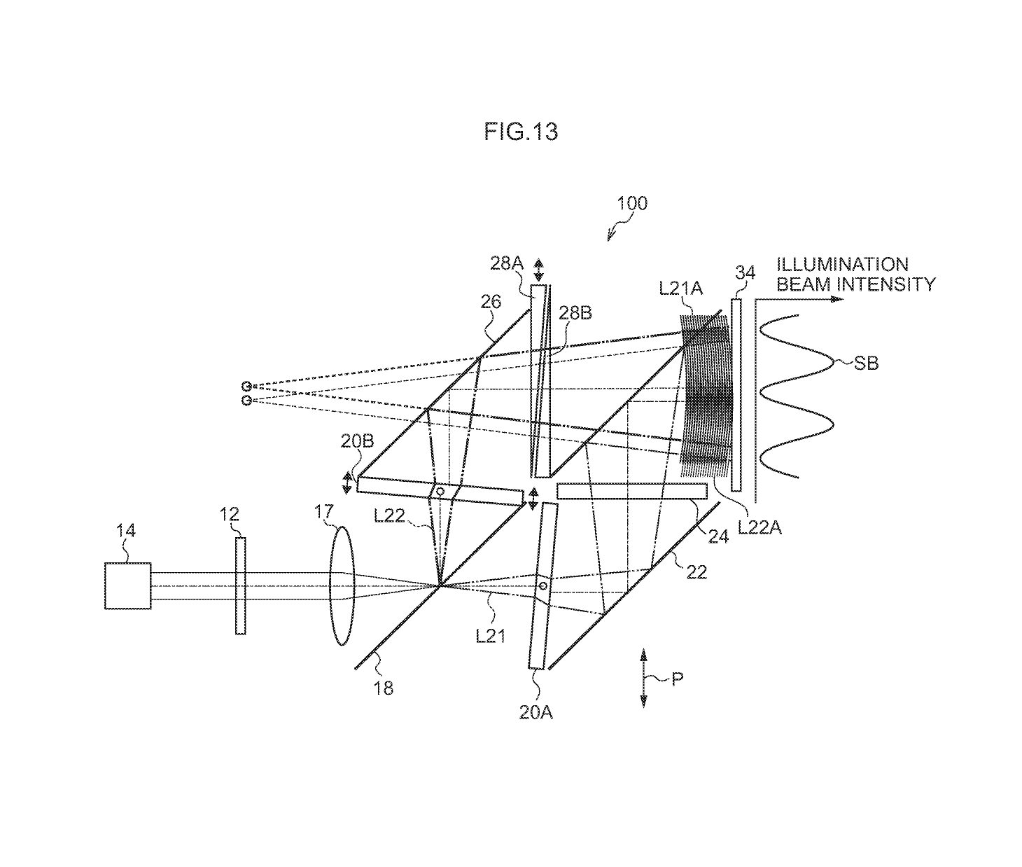

FIG. 14 is a configuration diagram of a defect detection apparatus according to a related example.

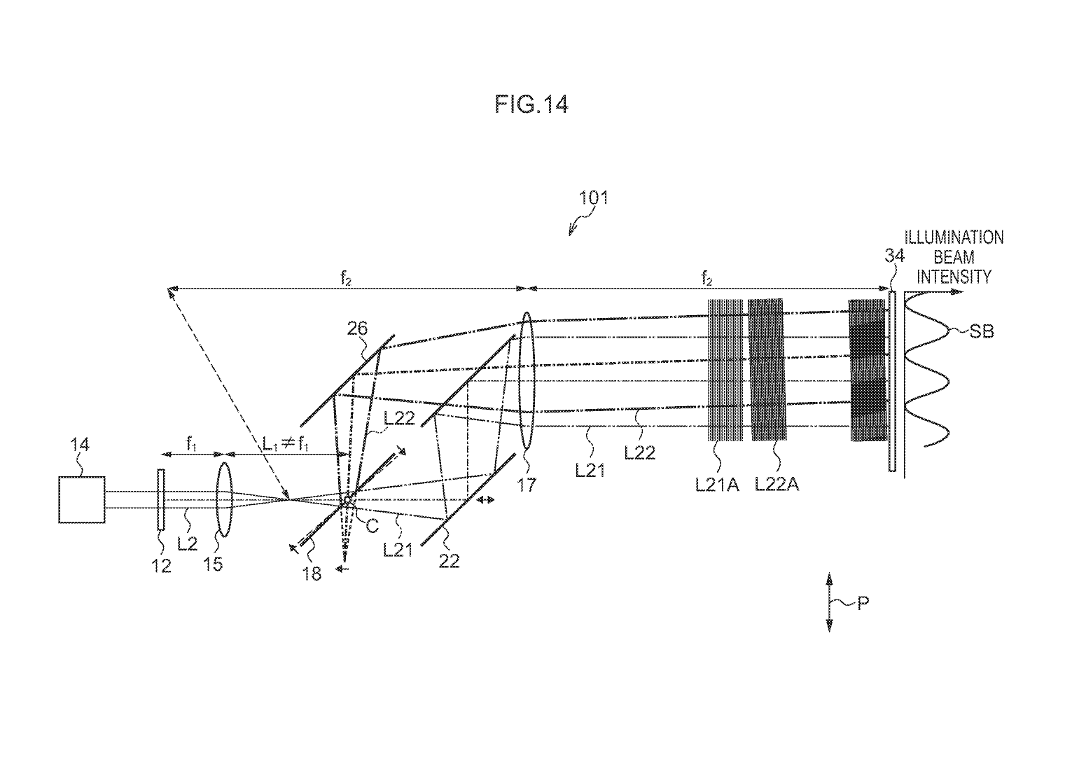

### DETAILED DESCRIPTION

Explanation follows regarding an exemplary embodiment of the present invention, with reference to the drawings.

### First Exemplary Embodiment

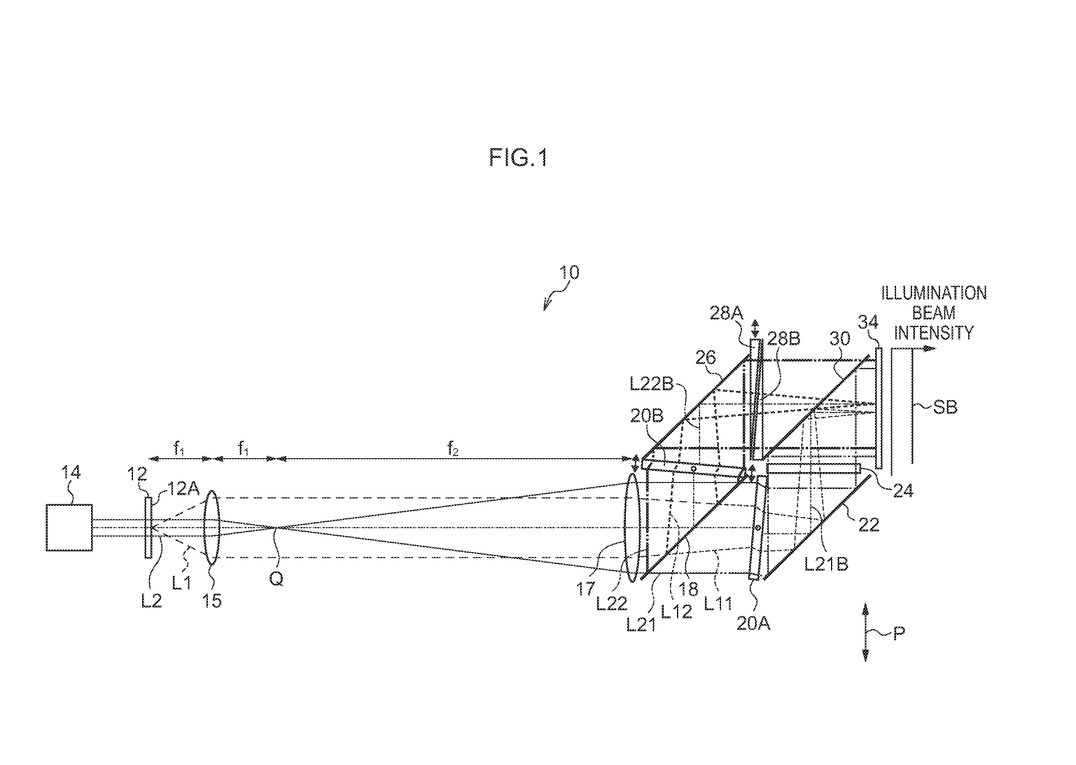

FIG. 1 illustrates a defect detection apparatus 10 according to the first exemplary embodiment. The defect detection apparatus 10 is an apparatus for detecting defects in a nanoimprint mold 12 formed with a predetermined pattern of nanometer size. Portions of the defect detection apparatus 10 similar to the above defect detection apparatus 100 are allocated the same reference numerals.

The nanoimprint mold 12 is manufactured by nanoimprint lithography (NIL) using a light transmitting material, such as quartz for example. A predetermined pattern is formed on one face 12A of the nanoimprint mold 12, with a pattern width and pattern pitch of several nm to several tens of nm.

As shown in FIG. 1, the defect detection apparatus 10 is a field separation interference microscope, configured including: a light source 14 that illuminates a parallel light illumination beam onto the nanoimprint mold 12; an object lens 15 that converges light that has passed through the nanoimprint mold 12; a focusing lens 17 that converges light that has passed through the object lens 15; a half-mirror 18 that splits scattered light L1 that has passed though the focusing lens 17 into scattered light L11, L12 and splits an illumination beam L2 into illumination beams L21, L22; a deflector 20A that deflects light that has passed through the half-mirror 18; a mirror 22 that reflects the light deflected by the deflector 20A towards a specific direction; a phase compensation plate 24 for performing phase compensation; a deflector 20B for deflecting light reflected by the half-mirror 18; a mirror 26 that reflects the light deflected by the deflector 20B towards a specific direction; a phase shifter 28 that shifts the phase of light from the mirror 26; a half-mirror 30 for letting light pass through from the phase shifter 28 and wave combining by reflecting light from the phase compensation plate 24; and an imaging element 34 for capturing an image of light from the half-mirror 30.

Out of the light passing through the nanoimprint mold 12, the scattered light L1 is made into parallel light by the object lens 15, and the illumination beam L2 first converges before diverging and being incident on the focusing lens 17.

The light that has passed through the focusing lens 17 is incident on the half-mirror 18. Out of the light incident on the half-mirror 18, the scattered light L1 is split into scattered light L11 that passes through the half-mirror 18, and scattered light L12 that is reflected by the half-mirror 18, and the illumination beam L2 is split into the illumination beam L21 that passes through the half-mirror 18 and the illumination beam L22 that is reflected by the half-mirror 18.

The scattered light L11 and the illumination beam L21 passing through the half-mirror 18 go on to pass through the deflector 20A, and are then reflected towards the phase compensation plate 24 by the mirror 22.

The phase compensation plate 24 functions to adjust the relative phase difference between the scattered light L11 and the scattered light L12, and the illumination beam L21 and the illumination beam L22, namely function to adjust such that the optical path lengths of the scattered light L11 and the scattered light L12, and the optical path lengths of the illumination beam L21 and the illumination beam L22, are respectively the same as each other. The scattered light L11 and the illumination beam L21 that have passed through the phase compensation plate 24 are then incident on the half-mirror 30.

The scattered light L12 and the illumination beam L22 reflected by the half-mirror 18 pass through the deflector 20B and are reflected towards the phase shifter 28 by the mirror 26.

The phase shifter 28 is configured by wedge shaped prisms 28A, 28B. By shifting the prism 28A in the arrow P direction in the drawing, the optical path difference between the scattered light L11 and the scattered light L12, and the optical path difference between the illumination beam L21 and the illumination beam L22, can be adjusted according to the shift amount, namely the respective phase shift amounts can be adjusted.

The light from the phase shifter 28 and the light from the phase compensation plate 24 are wave combined by the half-mirror 30. The wave combined light makes an image on the imaging element 34.

The object lens 15 and the focusing lens 17 are disposed so such that the back focal point position of the object lens 15 and the front focal point position of the focusing lens 17 coincide with each other at the point Q in FIG. 1. The defect detection apparatus 10 accordingly configures a two sided telecentric optical system, hence out of the illumination beam L2 that has passed through the focusing lens 17, the illumination beam L21 and the main axis L21B of the illumination beam L21 that have passed through the half-mirror 18 are parallel to each other, and the illumination beam L22 and the main axis L22B of the illumination beam L22 that have been reflected by the half-mirror 18 are parallel to each other, and the illumination beams L21, L22 and the respective main axes of the illumination beams L21, L22 after either passing through or being reflected by the half-mirror 30 are all parallel to each other.

Accordingly, even though the illumination beams L21, L22 interfere with each other as shown in FIG. 1 there are no interference fringes formed in the captured image, and since the signal strength SB or the illumination beam is constant detection can be made at high precision when detecting for defects as described below.

Due to the defect detection apparatus 10 configured as described having a field separation function, a single image point and a conjugates object point can both be formed on the imaging element 34. More specifically, parallel shifting can be performed so that the two separated light beams move apart from each other in a direction parallel to the image plane of the imaging element 34 (an arrow P direction) when the deflectors 20A, 20B are inclined with respect to the optical axes by respective specific angles θ in opposite directions. Accordingly, by tilting the deflectors 20A, 20B by the specific angle θ, out of the two object points P1, P2 separated by the separation distance D in the arrow P direction on the nanoimprint mold 12, an interference image resulting from interference between a field separation image of light from the object point P1 and a field separation image of light from the object point P2 can be formed as an image on the imaging element 34.

Consequently, light from the two object points separated on the nanoimprint mold 12 can be caused to interfere and an image can be formed on the imaging element 34 by inclining the deflectors 20A, 20B by a specific angle θ that depends on the separation distance D.

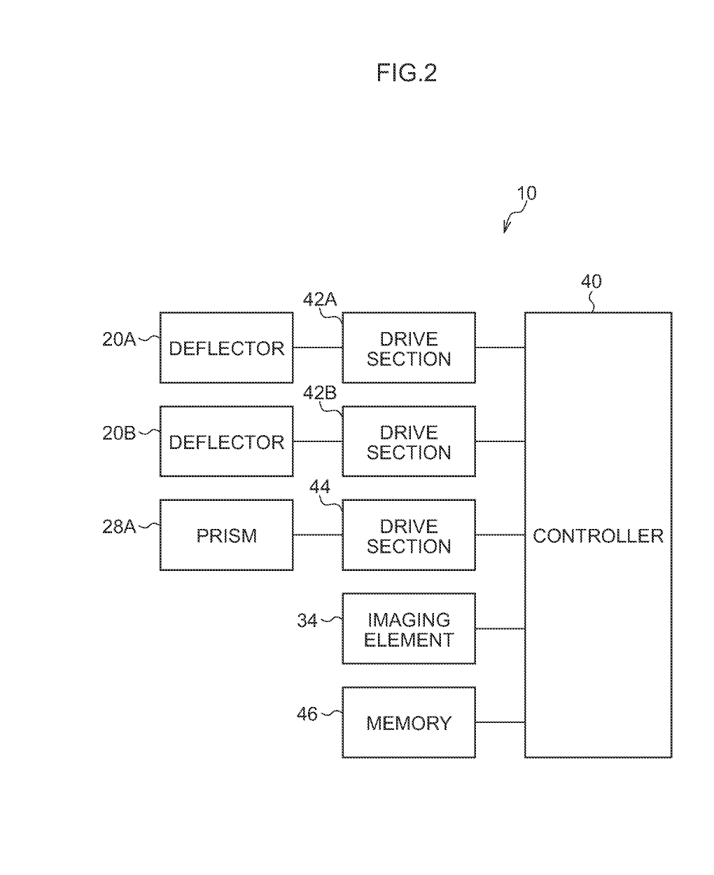

FIG. 2 is a block diagram illustrating a control system of the defect detection apparatus 10. As shown in FIG. 2, the defect detection apparatus 10 is equipped with a controller 40. The controller 40 is connected to a drive section 42A for driving the deflector 20A, a drive section 42B for driving the deflector 20B, a drive section 44 for driving the prism 28A of the phase shifter 28, the imaging element 34 and a memory 46.

Explanation follows regarding detecting an isolated defect with the defect detection apparatus 10, and regarding a simulated result from electromagnetic field analysis optics simulation.

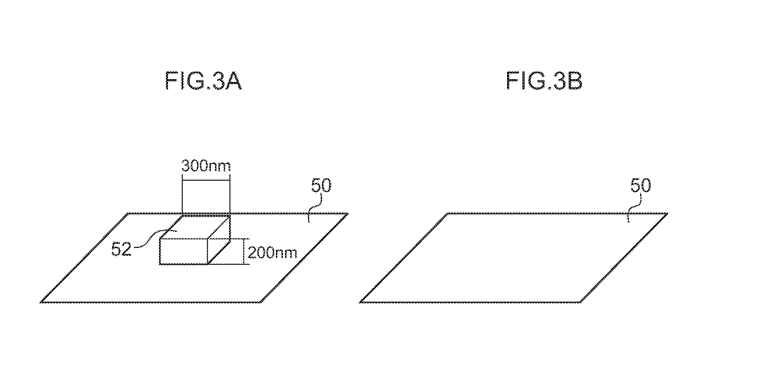

In the simulation, as shown in FIGS. 3A and 3B, a case is simulated in which, as an example, a rectangular box-shaped isolated defect of length and width 300 nm and height 200 nm present on a flat planar region 50 of the nanoimprint mold 12 is detected as a projecting portion 52.

The object point P1 is a projecting portion 52 on the flat planar region 50, and the object point P2 is a point on the flat planar region 50 separated from the projecting portion 52 by the separation distance D. Explanation follows regarding a simulation in which an interference image from interference between an image of light from the projecting portion 52 and an image of light from the flat planar region 50 is achieved by tilting the deflectors 20A, 20B by the angle θ corresponding to the separation distance D in opposite directions. The simulation investigates the state of the interference image as the phase difference φ=π−Δ between the two separated beams is changed using the phase shifter 28. A is the phase shift amount (bias phase). The wavelength of the illuminated light is, for example, 638 nm.

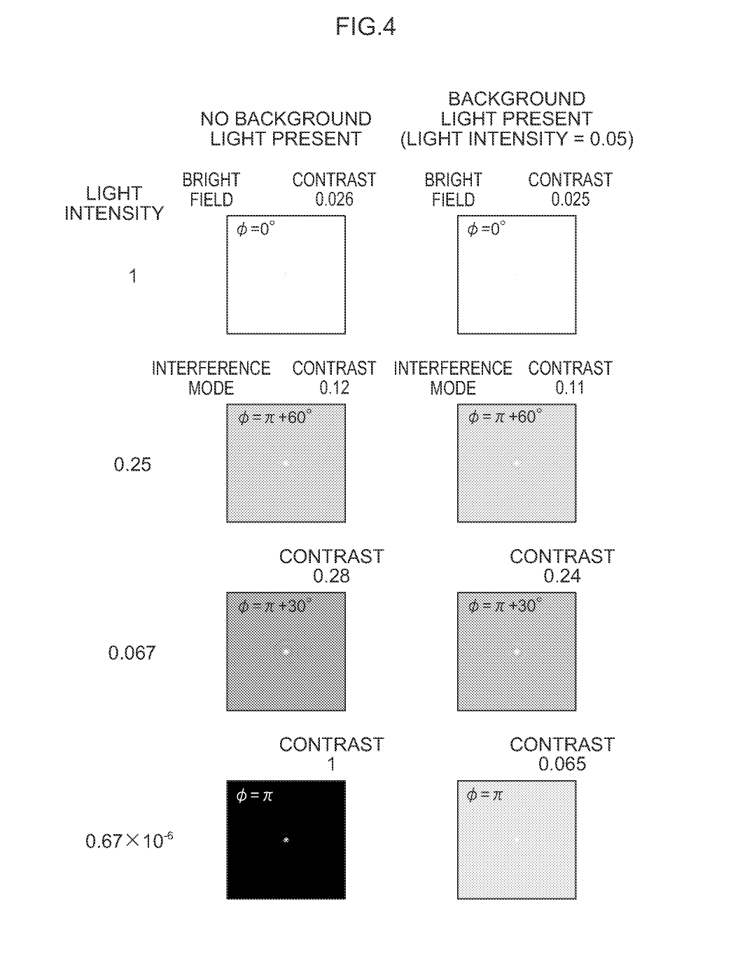

FIG. 4 illustrates the simulation results of the interference image when there is no background light and when there is background light for each of a phase difference φ=0° (Δ=π, wherein Δ is the bias phase), φ=π−60° (Δ=60°), φ=π−30° (Δ=30°), φ=π(Δ=0°. The background light is scattered light caused by defects in optical members or by dirt/scratches/dust, for example, escaping light such as from a mirror tube or holder, or light generated by dark current, noise or the like.

When there is no background light then this represents an ideal case envisaging no background light from defects or dirt on the nanoimprint mold 12 or other optical members.

The light intensity of background light when present is set at 0.05. This value is based on a value of light intensity of 1 when the phase difference φ=0°, namely a bright field image without interference between the two separated light beams.

The projecting portion 52 cannot be detected for a bright field image at phase difference φ=0°, whether or not there is background light present. When the phase difference φ=π, due to the images interfering of the two separated beams with phases misaligned with each other by π, in an ideal state with no background light, the images of portions the same in the two images cancel each other out, but the portions that are different in the two images, namely only the portions of the projecting portion 52, appear bright. This results in an extremely high contrast of 1, however the signal light intensity is extremely small due to the light intensity being proportional to the sixth power of the size.

However, in practice there is normally background light present caused by defects in optical members or by dirt/scratches/dust. Consequently, as shown in FIG. 4, when there is background light present and φ=π, the contrast is reduced to 0.065 due to being affected by the background light, and it is difficult to detect the projecting portion 52.

In contrast thereto, as shown in FIG. 4, even when there is background light present the contrast is higher for φ=π−30° and φ=π−60° than when φ=0° or π, enabling detection of the projecting portion 52. The signal light intensity from the projecting portion 52 can be increased in amplitude by making the phase difference φ of the two separated beams π−Δ. Accordingly, even in actual measurement systems in which there is background light present, detection with good precision is possible for defects of nanometer size, smaller than the wavelength of the illumination beam, by controlling the phase difference φ.

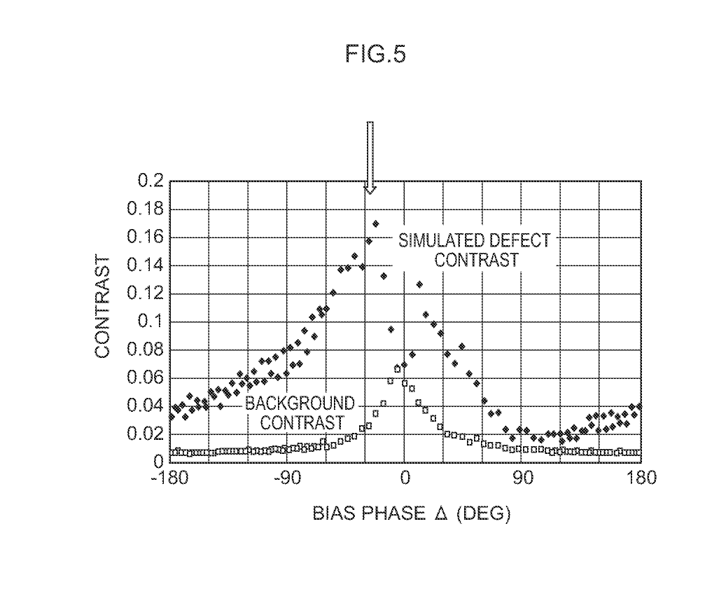

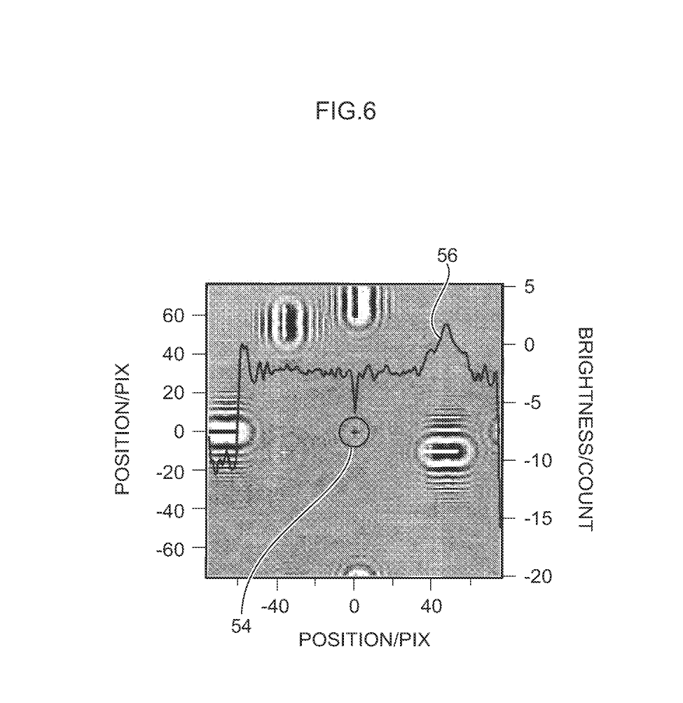

FIG. 5 illustrates simulation results for the contrast of a simulated defect 54 in a measurement image when the simulated defect 54 like that of FIG. 6 is imaged by the defect detection apparatus 10, and the contrast of background light. The size of the simulated defect 54 is length and width of 500 nm and height of 200 nm, the NA of the aperture of the optical system of the defect detection apparatus 10 is 0.45. Line 56 of FIG. 6 shows the brightness on a line including the simulated defect 54. The horizontal axis in FIG. 5 is the bias phase, namely Δ, and the vertical axis is the contrast. As shown in FIG. 5, in the bright field image when Δ=0°, namely when φ=π, the contrast of the simulated defect is substantially the same as the contrast of the background light, making it difficult to detect the defect. In the bright field image when Δ=π, namely when φ=2π(0°), the simulated device contrast is also low, and it is also difficult to detect the defect. The contrast reaches a maximum close to Δ=−30°.

Accordingly, even when there is a defect of size less than the wavelength of the illuminated light, the defect can be detected by setting the phase difference between the two separated beams to π−66 , rather than to π. Note that Δ is set according to the light intensity of background light, for example, the greater the light intensity of background light the larger the value set for Δ. Δ is set such that the contrast of the defect portion and the contrast of the background light are contrasts sufficient to enable detection of the defect portion.

In the defect detection apparatus 10, the controller 40 instructs the drive section 44 to drive the prism 28A such that the phase difference φ between the two separated beams satisfies φ=π−Δ, and the nanoimprint mold 12 is imaged by the imaging element 34. An interference image in which the defect portion is emphasized can thereby be obtained, and isolated defects smaller in size than the wavelength of illuminated light can be detected with good precision.

Explanation follows regarding a nanoimprint mold 12 employed, for example, in fabrication of a semiconductor circuit board, regarding detection of a defect in periodic circuit pattern formed on the nanoimprint mold 12.

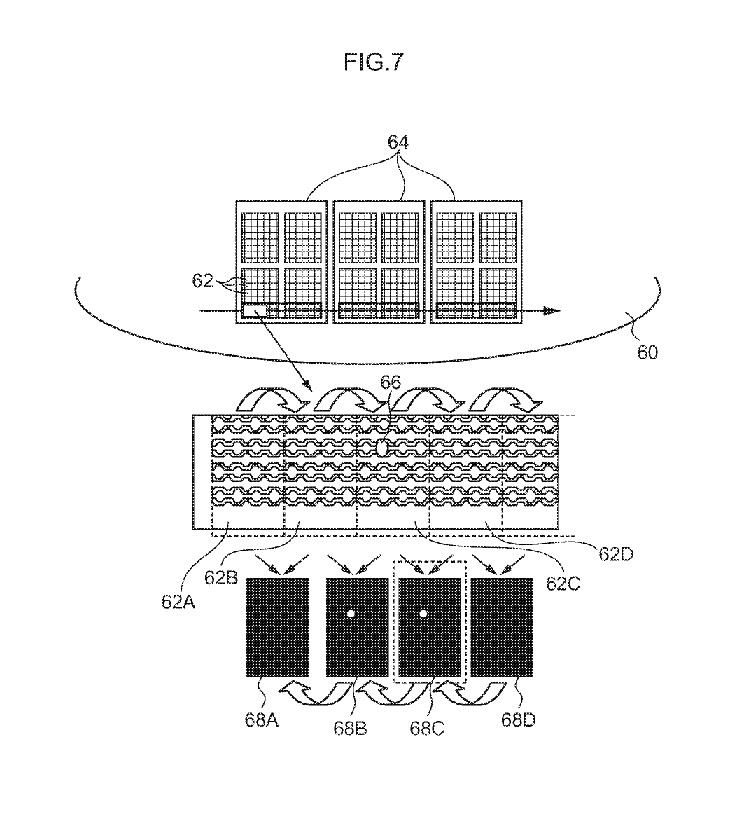

As shown in FIG. 7, when detecting defects on a nanoimprint mold 12 when forming plural dies 64 including plural repetitions of cells 62 of the same circuit pattern, the circuit patterns can be made to cancel each other out and a defect can be detected by interfering a reference beam from a nearby, preferably adjacent, cell 62 with the measurement beam. Namely, by setting separation distance D as the interval to the reference cell by inclining the deflectors 20A, 20B by an angle θ corresponding to the separation distance D, and then driving the prism 28A of the phase shifter 28 such that the phase difference between the two separated beams from adjacent cells is φ=π−Δ an interference image of interference between two beams from comparison cells is captured by the imaging element 34. Δ is determined according to the light intensity of background light as described above.

When, for example, there is a defect 66 present in the cell 62C and the reference cell 62B is a normal cell with no defect present, then in an interference image 68B from the two images, as shown in FIG. 7, this results in an image emphasizing the differences between the two cells, namely emphasizing only the defect 66 (the white round portion in the drawing), with the other portions cancelling each other out. A similar phenomenon is observed in the interference image formed with the other reference cell 62D. Accordingly, a defect in a cell of a circuit pattern of periodic structure can be detected.

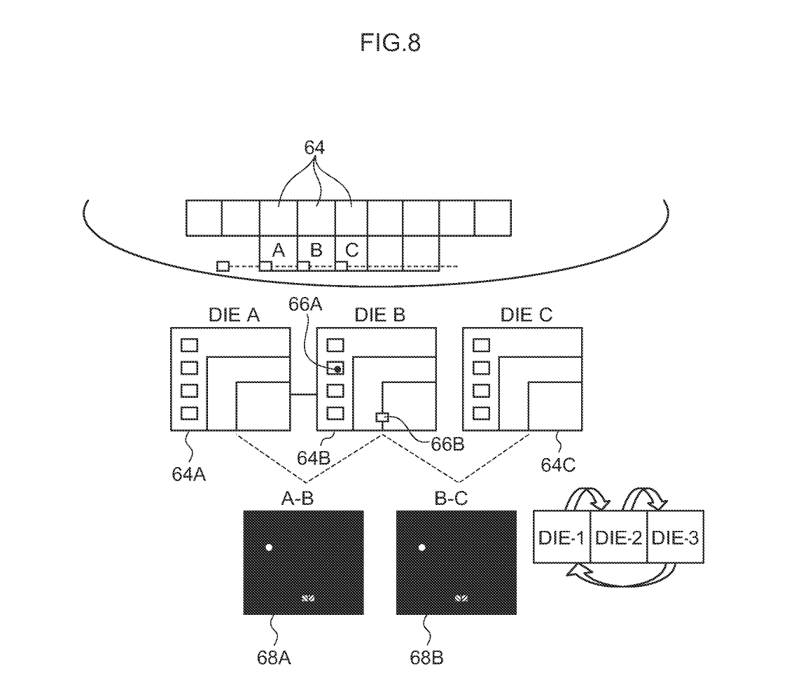

Similarly, when there are plural adjacent dies 64 each of the same pattern, a defect can be detected by imaging an interference image from interfering a reference beam from a nearby, preferably adjacent, die 64 with the measurement beam. For example, as shown in FIG. 8, when there are the defects 66A, 66B present in the die 64B, the interference image 68A with the normal die 64A results in an image in which the defects 66A, 66B are emphasized, as shown in FIG. 8. Similar applies to an interference image with the normal die 64C.

In the first exemplary embodiment, as stated above, optical members are disposed from the object lens 15 to the focusing lens 17 such that the back focal position of the object lens 15 and the front focal position of the focusing lens 17 coincide with each other at the position of point Q in FIG. 1, so as to configure a two sided telecentric optical system. Out of the illumination beam L2 that has passed through the focusing lens 17, the illumination beam L21 and the main axis L21B of the illumination beam L21 that has passed through the half-mirror 18, and the illumination beam L22 and the main axis L22B of the illumination beam L22 reflected by the half-mirror 18, are respectively parallel to each other, and the main axes of the illumination beams L21, L22 passing through or reflected by the half-mirror 30 are all respectively parallel to their main beams. Accordingly, even though the illumination beams L21, L22 interfere with each other, no interference fringe is formed in the captured image, and since the signal strength SB is constant. Defect detection can consequently be achieved at high precision.

### Second Exemplary Embodiment

Explanation follows regarding a second exemplary embodiment of the present invention. Similar portions to those of the defect detection apparatus 101 are allocated the same reference number and detailed explanation is omitted.

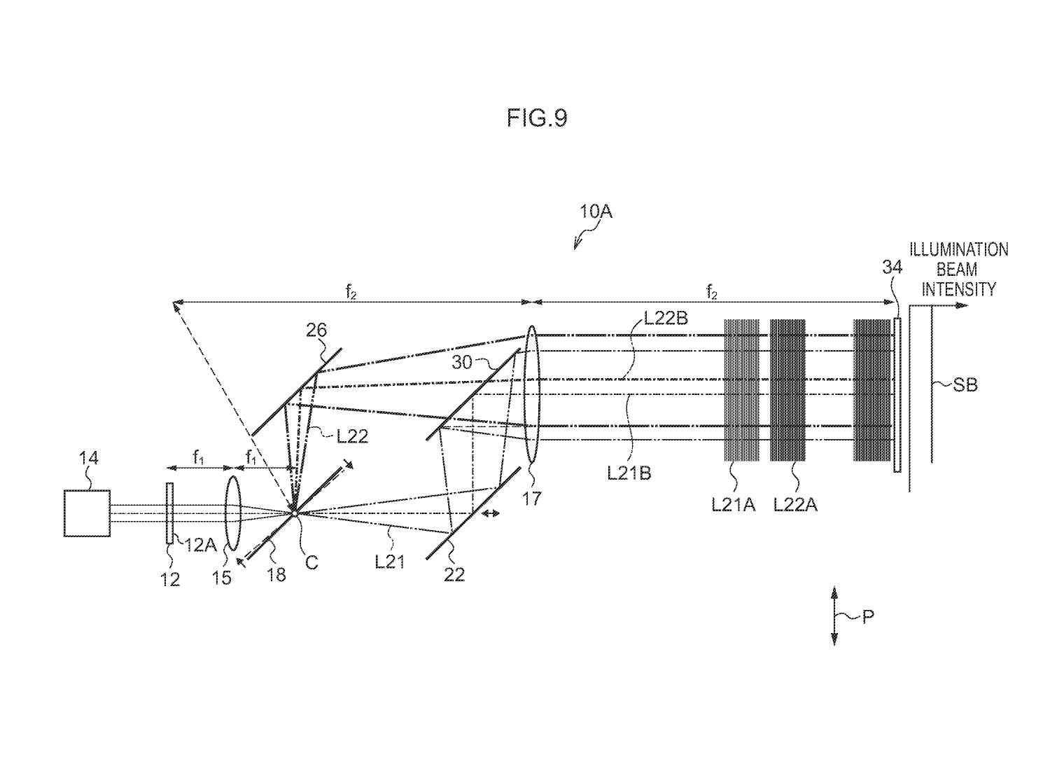

FIG. 9 illustrates a defect detection apparatus 10A according to the present exemplary embodiment. As shown in FIG. 9, the defect detection apparatus 10A has similar configuration members to those of the defect detection apparatus 101, however the defect detection apparatus 10A differs from the defect detection apparatus 101 in configuration as a two sided telecentric optical system. Namely, as shown in FIG. 9, the object lens 15 and the focusing lens 17 are disposed such that the back focal point position of the object lens 15 and the front focal point position of the focusing lens 17 coincide with each other at the deflection direction central point C of the half-mirror 18.

Accordingly, similarly to the first exemplary embodiment, since out of the illumination beam L2 that has passed through the focusing lens 17, the illumination beam L21 and main axis L21B of the illumination beam L21, and the illumination beam L22 and main axis L22B of the illumination beam L22 are respectively parallel to each other, the wave faces L21A, L22A of the illumination beams L21, L22 are also parallel. Consequently, even though the illumination beams L21, L22 interfere with each other interference fringes do not occur in the captured image, and the signal intensity SB of the illumination light is constant. Defect detection can hence be achieved with high precision.

### Third Exemplary Embodiment

Explanation follows regarding a third exemplary embodiment of the present invention. Portions similar to those of the defect detection apparatus 10A are allocated the same reference numerals and detailed explanation thereof is omitted.

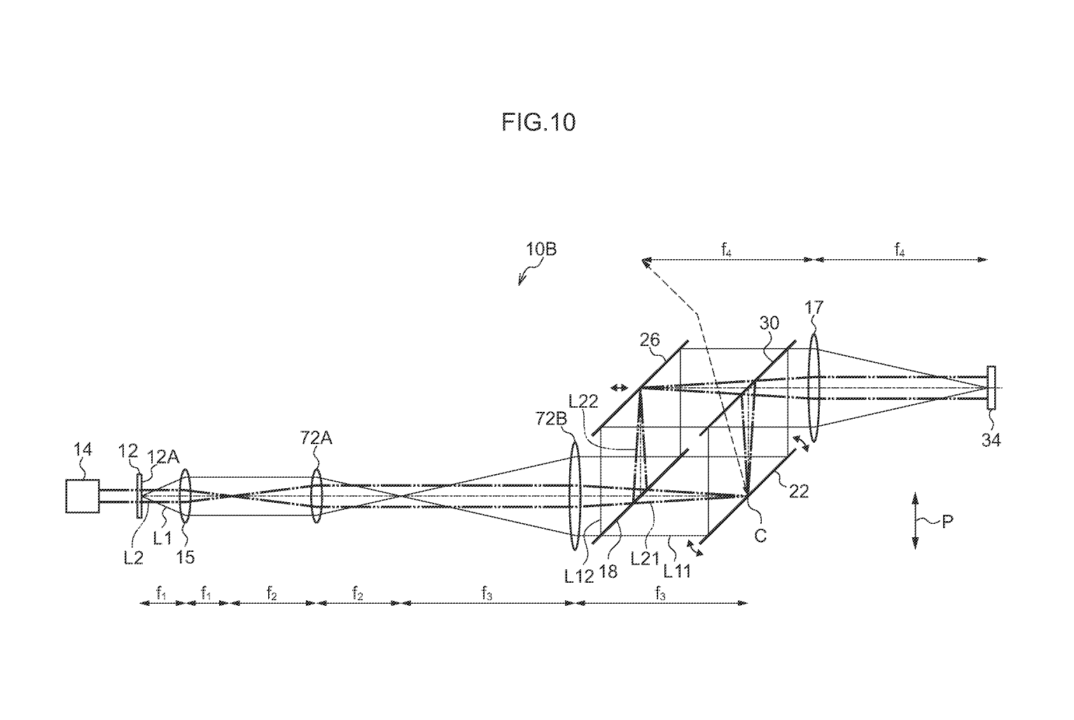

FIG. 10 illustrates a defect detection apparatus 10B according to the third exemplary embodiment. As shown in FIG. 10, the defect detection apparatus 10B differs from the defect detection apparatus 10A in that: relay lenses 72A, 72B are provided between the object lens 15 and the half-mirror 18; the mirror 22 is also employed as a deflector; and the mirror 26 is also employed as a phase shifter.

The optical system components from the object lens 15 to the focusing lens 17 are disposed such that the back focal point position of the object lens 15 and the front focal point position of the focusing lens 17 coincide at the deflection direction central point C of the mirror 22.

In this exemplary embodiment, similarly to the second exemplary embodiment, out of the illumination beam L2 when it has passed through the focusing lens 17, the illumination beam L21 and the main axis L21B of the illumination beam L21, and the illumination beam L22 and the main axis L22B of the illumination beam L22 are respectively parallel to each other. Consequently, even though the illumination beams L21, L22 interfere with each other interference fringes do not occur in the captured image, and the signal intensity SB of the illumination light is constant. Defect detection can hence be achieved with high precision.

Due to provision of the relay lenses 72A, 72B between the object lens 15 and the half-mirror 18, the degrees of freedom in the interferometer position from the half-mirror 18 to the half-mirror 30 can be raised.

### Fourth Exemplary Embodiment

Explanation follows regarding a fourth exemplary embodiment of the present invention. Portions similar to those of the defect detection apparatus 10B are allocated the same reference numerals and detailed explanation is omitted.

In the fourth exemplary embodiment explanation is of a defect detection apparatus employing a periodic pattern cut mask for cutting diffracted light due to periodic patterns formed on the nanoimprint mold 12.

For example, in a memory device such as SRAM, there is generally a regular periodic circuit pattern maintained within a single chip. In such a case, a nanoimprint mold 12 for forming such a circuit pattern also has a repeating pattern with a periodicity larger than the wavelength of the illumination light. Due to such a repeating pattern acting as a diffraction grid on the illumination light to generate diffracted light in characteristic angles. Accordingly, when the diffracted light from the periodic circuit pattern is brighter than the signal light intensity from a defect of a few nm to a few tens of nm then sometimes the ability to detect a defect is reduced.

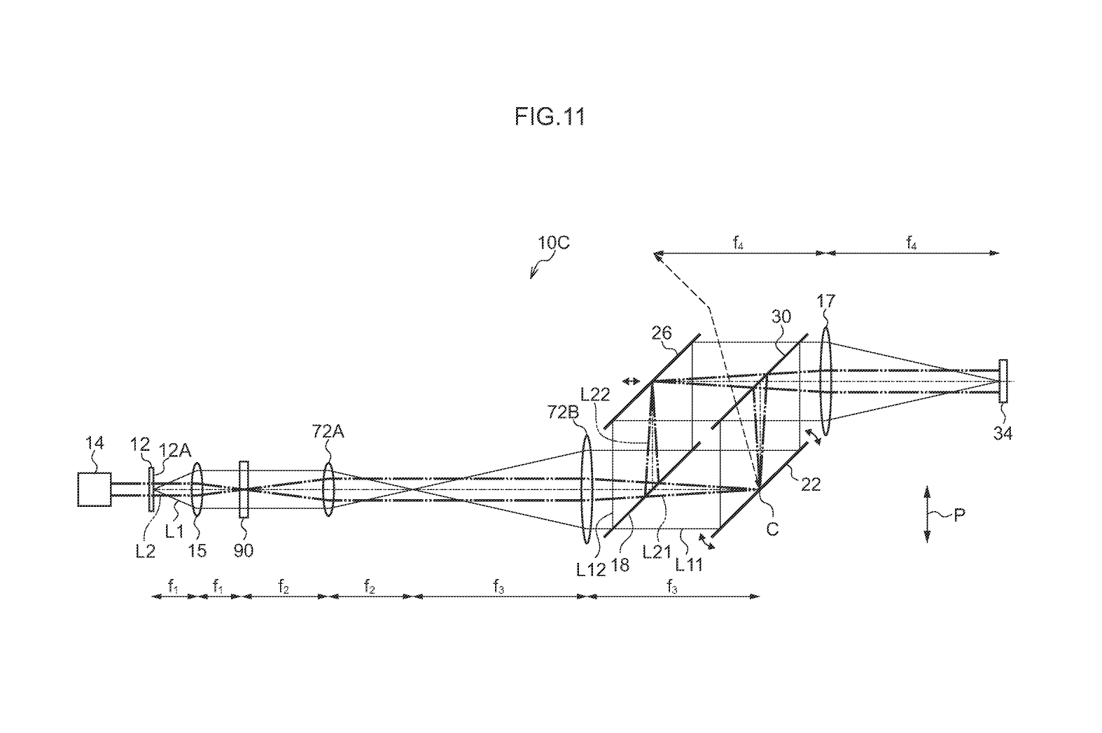

As shown in FIG. 11, the defect detection apparatus 10C according to the present exemplary embodiment is provided between the object lens 15 and the relay lens 72A with a periodic pattern cut mask 90 formed with a Fourier transform pattern on a Fourier transformation plane, where an optical image of a Fourier transform pattern is formed corresponding to the pattern formed on the nanoimprint mold 12.

The periodic pattern cut mask 90 is configured, for example, by birefringent elements, liquid crystals or the like. The controller 40 in such a case controls the periodic pattern cut mask 90 such that a Fourier transform pattern corresponding to the periodic pattern formed on the nanoimprint mold 12 is formed (displayed).

Disposing the periodic pattern cut mask 90 at the Fourier transform plane enables diffracted light due to the periodic circuit pattern to be cut, and hence the defect portions can be detected with high precision.

The present invention is not limited to the above exemplary embodiment and obviously various modifications and improvements are possible within a scope not departing from the technical intention as recited in the scope of patent claims. For example, as a method to obtain an interference image of a defect detection apparatus according to the present exemplary embodiment, while there are the examples in the present exemplary embodiments of a Mach-Zehnder method (see FIG. 1), another method may also be applied as appropriate, such as, for example, a Jamin method, a Michelson method, a Fizeau method, or a Twyman-Green method.

What is claimed is:

1. A defect detection apparatus comprising:
a light illumination section that illuminates an illumination beam onto a detection subject that transmits light and is formed with a predetermined pattern;
a group of lenses including an object lens and a focusing lens for focusing the illumination beam illuminated on and passing through the detection subject;
a light splitter section that splits the light passing through the lens group into two beams;
a deflecting section that deflects at least one of the two beams from the two split beams so as to be laterally shifted along a predetermined direction;
a phase shifting section that shifts the phase of the at least one of the beams from the two beams deflected by the deflecting section;
a wave combining section that wave combines the two beams phase shifted by the phase shifting section; and
an imaging section that captures an optical image of light wave combined by the wave combining section, wherein the object lens and the focusing lens are disposed such that two beams that have passed through the focusing lens are parallel to each other and the main axes of the two beams that have passed through the focusing lens are parallel to each other.

2. The defect detection apparatus of claim 1, wherein the object lens and the focusing lens are disposed such that the back focal point position of the object lens and the front focal point position of the focusing lens coincide with each other.

3. The defect detection apparatus of claim 2, wherein:
the focusing lens is provided between the wave combining section and the imaging section; and
the light splitter section comprises a half-mirror that causes a portion of the light passed through the object lens to pass through and reflect another portion of the light passed through the object lens;
the light splitter section also functions as the deflecting section; and
the object lens, the focusing lens and the half-mirror are disposed such that the deflection direction central point of the half-mirror is at the back focal point position of the object lens and at the front focal point position of the focusing lens.

4. The defect detection apparatus of claim 2, wherein:
a relay lens is provided on an optical path between the object lens and the focusing lens; and
the deflecting section is also employed as a mirror that reflects the light that has passed through the half-mirror towards the wave combining section, and the object lens, the focusing lens and the half-mirror are disposed such that the deflection direction central point of the mirror is at the back focal point position of the object lens and at the front focal point position of the focusing lens.

5. The defect detection apparatus of claim 4, further comprising a mask section disposed at a Fourier transform plane where an optical image of a Fourier transform pattern corresponding to the pattern is formed, the mask section configured to cut out an optical image of the Fourier transform pattern.

6. The defect detection apparatus of claim 1, wherein the focusing lens is provided between the object lens and the light splitter section.

7. The defect detection apparatus of claim 1, wherein:
the light illumination section illuminates an illumination beam of wavelength greater than nanometer size onto a nanoimprint mold that transmits light and is formed with a predetermined pattern of nanometer size; and
the phase shifting section shifts the phase of at least one of the beams from the two beams such that the phase difference between the two beams deflected by the deflecting section is π−Δ(−90°<Δ<90°).
